(19) United States
(12) Patent Application Publication
(10) Pub. No.: US 2004/0055197 A1
(43) Pub. Date: Mar. 25, 2004

(54) Personalized house number plaques

(76) Inventor: Derrick House, Leawood, KS (US)

Correspondence Address: Robert G. Lev, 4766 Michigan Boulevard, Youngstown, OH, 44505, US

(21) Appl. No.: 10/255,724

(22) Filed: Sep. 25, 2002

(51) Int. Cl. G09F 7/02

(52) U.S. Cl. 40/618

(57) ABSTRACT

An improved mounting plaque system for house numbering includes symbols that are mounted by means of a rear connection in order to leave the front surfaces of the symbols unmarred by holes or other connection devices. The mounting plaque system also has mounting connections predetermined mounting hole pattern through the entire thickness of the mounting plate aligned with predetermined holes on the rear face of the symbols in order to fix the symbols the front surface of the mounting plate. The font of the symbols can be modified in order to maximize the number of mounting connections on the rear face of the symbols that align with mounting holes on the mounting plate.

### FIELD OF THE INVENTION

The present invention is in the field of mounting plaque systems. In particular, the present invention is directed to a mounting plaque system in which symbols such as letters and numbers are installed without altering their facades.

### BACKGROUND ART

Conventional art related to symbol mounting plaque systems, such as house numbering systems, is widely varied. Examples are U.S. Pat. Nos. 4,014,118; 3,987,568; 2,645,317; 1,896,131; 1,742,807; 1,691,638; 1,612,035; 1,135,726; and, 416,075; and British Patent No. GB002047452A, all directed to various mounting plaque systems. These patents are incorporated herein by reference, disclosing some of the structures and techniques from when the present invention was developed.

In general, the conventional art does not combine all the appropriate desired features into a single mounting plaque system. Some of the conventional art addresses one type of problem or goal while ignoring others. For example, some examples of conventional art facilitate ease of mounting while sacrificing a smooth front surface that would be resistant to weather damage.

Other conventional art achieves a smooth weatherproof front surface for the mounted symbols (letters and numbers) but does not permit easy mounting or handling of the mounting plate or symbols. Still other conventional art possesses a predetermined hole patterns on the mounting plate and a coordinated hole pattern on the symbols while using a frontal mounting method that alters the surfaces of the letters and numerals constituting the symbols.

Coordinating the pattern of pre-drilled holes in the mounting plate and the symbols to be mounted on the plate has often been very problematical in the conventional art. Developing a hole pattern that can accommidate at least two points for connection on each symbol is often very difficult, and has been known to lead to the necessity of an extremely large number of holes on the mounting plate. This can could an unsightly appearance, and it can often lead to confusion when trying to line up the connection points on the symbols with the pre-drilled holes on the mounting plate. Thus, while the use of a coordinated, pre-drilled hole pattern on a mounting plate is an advantage provided in the conventional art, it still admits to improvement.

Despite the improvements illustrated by the various examples of the conventional art, there still are drawbacks and problems to be solved. Further, this is room for additional improvement to optimize such systems.

### SUMMARY OF THE INVENTION

It is one object of the present invention to provide an improved symbol mounting plaque system, for house numbering and the like.

It is a further object of the present invention to provide a symbol mounting plaque system in which the symbol faces are smooth and unaltered by mounting devices.

It is another object of the present invention to provide a symbol mounting plaque system that has a cleaner, more polished look to the symbols and front surface than is found with many conventional systems.

It is an additional object of the present invention to provide a symbol mounting plaque system that resists weather, limiting surface corrosion that might result from front mounting devices.

It is still a further object of the present invention to provide a symbol mounting plaque system that possesses a simple hole pattern on both symbols and plaque.

It is yet another object of the present invention to provide a symbol mounting plaque system that possesses a universal hole pattern to which all symbols can be applied.

It is again further object of the present invention to provide a symbol mounting plaque system whose symbols possess predetermined mounting holes for ease of mounting.

It is still an additional object of the present invention to provide a symbol mounting plaque system which allows for easy interchangeability of symbols.

It is yet a further object of the present invention to provide a symbol mounting plaque system accommodating a wide range of symbols, including numbers, letters and the like.

It is still another object of the present invention to provide a symbol mounting plaque system that is easy to assemble.

It is again a further object of the present invention to provide a symbol mounting plaque system in which all mounting work on the plaque can be done through the rear face of the plaque.

It is yet an additional object of the present invention to provide a symbol mounting plaque system that can be assembled using commonly available mounting screws.

These and other goals and objects of the present are achieved by a symbol mounting plaque system including a mounting plate having a front surface and a rear surface. A predetermined pattern of mounting holes extend through the entirety of the mounting plate. Also included is at least one symbol arranged to be mounted on the mounting plate. The symbol has a smooth unmarked front surface and rear mounting holes matching in at least part the predetermined pattern of mounting holes on the mounting plate. At least one connecter is arranged to enter the rear face of the mounting plate and extend into a rear mounting hole on the symbol, mating there with to hold the symbol to the mounting plate.

In another embodiment of the present invention a method of mounting smooth-faced symbols to a mounting plate is carried out by creating a predetermined pattern of holes through the entire thickness of the mounting plate. Next, a modified font is font is created for the symbols to maximize the common points on the symbols with the predetermined pattern of mounting holes. Mounting connections are created on the rear of the symbols to match at least in part the predetermined mounting hole pattern. Finally, the symbols are placed on the mounting plate and connectors are passed from the rear of the mounting plate into the rear of the symbols at the mounting connections.

### BRIEF DESCRIPTIONS OF THE DRAWINGS

FIG. 1 is a front view of an address plaque arranged in accordance with the present invention;

FIG. 2 is a front view of the mounting plate of the invention;

FIG. 3 is a rear view of a numeral to be used with the present invention; and

FIG. 4 is a side sectional view of the invention.

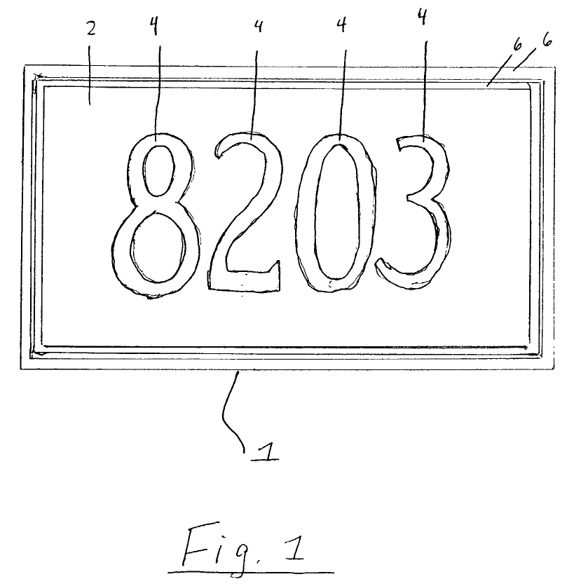

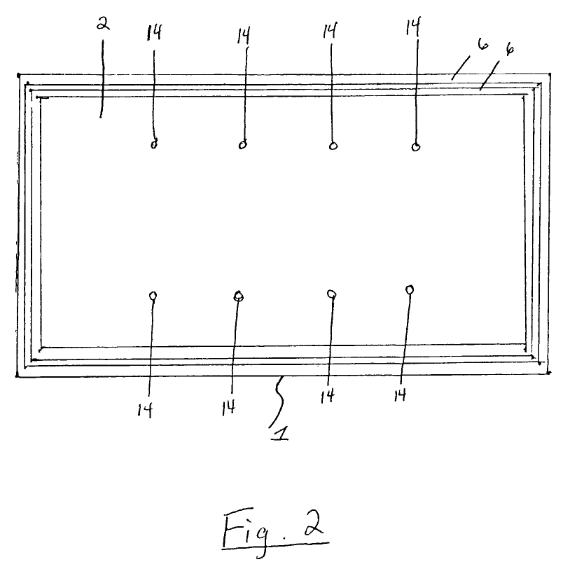

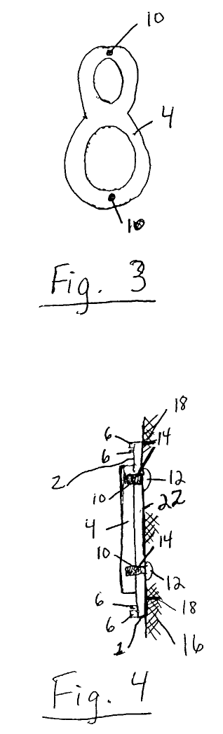

### DETAILED DESCRIPTION OF THE PREFERRED EMBODIMENTS

The present invention is a symbol mounting plaque system, which uses a mounting plate 1 having a front face 2 and rear surface 22. Symbols 4 such as alphanumeric characters are mounted on the front face 2 of the plate 1. The plate itself is mounted with its rear face 22 to a substrate 16 such, as the wall of the building. The present invention is particularly useful for house numbering or building identification systems. However, the present invention can be used in any number of different applications where an identity marker is appropriate.

Preferably, all parts of the present invention are made of brass since this is a highly decorative material, which is consistent with the preferred purpose of the present invention, decorative building markers. Also, brass is a material that is easy to work with in the manufacturing process, and relatively easy to modify in the field. This means that the mounting plaque system of the present invention is highly flexible with regard to being mounted to various structures using various types of connectors 18 (FIG. 4). Connection to the substrate 16 is generally effected by holes at the corner of the mounting plate 1 (through where connectors 18 pass). However, other techniques can be used, including: adhesives, hooks, or mounting frames.

While the mounting plate 1 and symbols 4 (preferably alphanumeric) are made of brass in the first preferred embodiment, a wide range of materials can be used within the concept of the present invention. For example, wood plaques and letters are well-known in marking systems. Other metals, such as aluminum or stainless steel can also be used. Further, different combinations of materials, especially various metals, can be included as part of the concept of the present invention. Nor is the present invention limited to wood or metal. Various kinds of plastics or rubber can also be used for either the symbols or the mounting plate.

The present invention includes a decorative brass trim 6 that is placed along the borders of the front surface 2 of the mounting plate 1. While this decoration is not necessary to the invention, in the preferred embodiment it improves the front physical appearance. Other decorative devices can also be used to enhance the appearance of the invention mounting system.

One of the advantages of the present invention is found in the mounting arrangement of the symbol 4. In many conventional mounting arrangements, ease of mounting is achieved only by driving mounting connectors through the faces of the symbols 4. In contrast, the present invention provides for smooth, unmarred front surfaces or faces for the symbols. This is achieved by using only rear mounting devices or connectors for the symbols 4.

There is a pattern of pre-drilled holes 14 through the mounting plate 1. Through connectors 12 (such as machine screws) are deployed from the rear face of the mounting plate 1, through the entire thickness of the plate and extend from the front surface 2 of the plate for entry into the rear connectors 10 of the symbols 4. The through connectors 12 are fixed within the interior of symbols 4, thereby holding the symbols to the front face of plate 1. Preferably, the connectors 12 are standard threaded machine screws which mate with threaded holes constituting rear connector 10 in the rear of symbols 4.

However, the connection arrangement is not limited to standard threaded connectors. Rather, self-tapping screws can be used, as well as friction or pressure fit devices. It is conceivable that even adhesives could be used on smooth studs projecting from the front of the mounting plate 1, and into rear connectors 10 on the symbols 4. However, the use of adhesives would make any re-mounting operations somewhat problematical, and so are not as desirable as the use of standard threading connectors. In some arrangements, friction fit connectors could be desirable but often lack the security and reliability of threaded connectors.

A major problem with all such systems is the aligning of rear connectors such as threaded mounting holes 10 on the symbols with the predrilled mounting holes 14 on the mounting plate. In the conventional art, this has been addressed by means of a pre-determined pattern of pre-drilled holes 14 on the mounting plate 1, which is matched, at least in part, the pattern of connectors 10 formed on the symbols 4. Unfortunately, it has often been very difficult to find more than one connection point on some symbols to align with the pre-drilled hole pattern on the mounting plate. This drawback has been tolerated in the conventional art by a number of different compromises that are not forced upon the present invention.

One of the easiest of the conventional solutions is to alter the size of the symbols 4. However, when using an alphanumeric system such as that used to number a house or identify a building, enlarging certain letters at the expense of others has proven to be an unsightly option. The present invention includes a combination of a revised font for alphanumeric symbols, as depicted in Appendix A, matched with a predetermined pattern of holes 14 so that there is an increased alignment between the symbols and the hole pattern. This allows more connection points 10 for the symbol 4 to be held to the mounting plate 1.

Examples of the revised font and the particular hole pattern 14 are found in Appendix A, attached hereto. The revised font for the alphanumeric symbols 4 of the present invention are such that the symbols can be of uniform size for a particular size of hole pattern, and different size symbols are not necessary to match a particular pattern of holes. The key aspect of this characteristic of the present invention is that the shape of the font rather than the size of the symbol has been altered to better align with the predetermined hole pattern 14, as the hole pattern has been configured to better align with the shapes of standard alphanumeric symbols 4. While the specific fonts and pattern of holes depicted in Appendix A are optimized for the present invention, the specific pattern of holes and fonts are not absolutely necessary to practice the present invention. Rather, other fonts can be devised, as well as other patterns of holes to better match the fonts. Appendix A represents just one example of the present invention in operation.

Because the mounting holes 10 on the backs of the symbols 4 are aligned with the hole pattern 14 on the mounting plate, properly aligning the symbols for mounting becomes relatively simple, and the mounting procedure is performed very quickly. Thus, the ease of mounting alphanumeric symbols that is normally achieved by driving the connectors 12 through the front of the symbols is as easily achieved using connectors that enter only the rear of the symbols. As a result, the alphanumeric symbols are left unmarred by connecting devices, thereby presenting a more attractive appearance and preventing degradation from the weather for those materials that are vulnerable to it.

While a number of embodiments of the present invention have been described by way of example, the present invention is not limited thereby. Rather, the present invention is meant to encompass any variations, alterations, derivations, permutations, adaptations, and other embodiments that would occur to one skilled in this art having a knowledge of the present invention. Accordingly, the present invention is to be limited only by the bounds of the following claims.

I claim:

1. A symbol mounting plaque system comprising:
(a) a mounting plate having a front surface and a rear surface, and a predetermined pattern of mounting holes extending through the entire thickness of said mounting plate;
(b) at least one symbol arranged to be mounted on said mounting plate, said symbol having a smooth, unmarred front face and rear mounting connectors matching in at least part said predetermined pattern; and,
(c) at least one connector arranged to enter said rear face of said mounting plate, and extend into a rear mounting connector of said at least one symbol, mating therewith to hold said at least one symbol to said mounting plate.

2. The symbol mounting plaque system of claim 1 wherein said symbols are alphanumeric.

3. The symbol mounting plaque system of claim 1 wherein said symbols are modified in shape in order to correspond to said predetermined hole pattern.

4. The symbol mounting plaque system of claim 1 wherein said at least one connector is threaded and is engaged in threaded connectors in said symbols.

5. The symbol mounting plaque system of claim 1 wherein said plaque system is composed of brass.

6. The symbol mounting plaque system of claim 1 wherein said plaque system further comprises means for mounting said mounting plate onto a substrate.

7. A method of mounting smooth-faced symbols on a mounting plate having a front and rear face, the method comprises steps of:
(a) creating a predetermined pattern of mounting holes through the entire thickness of said mounting plate;
(b) creating a modified font for said symbols in order to maximize common points with said predetermined pattern of mounting holes;
(c) creating mounting connections on a rear portion of said symbols to match at least in part said predetermined mounting hole pattern; and,
(d) placing said symbols on said mounting plate and passing connectors from the rear of said mounting plate into the rear of said symbols at said mounting connecion.

8. The method of claim 7 wherein step (b) of creating a modified font for said symbols comprises the substep of altering the shape of said symbols.

9. The method of claim 7 wherein step (c) of connecting comprises mating with a threaded fastener.

10. The method of claim 7 wherein the step (d) of fastening comprises the formation of a pressure-fit connection.

11. The method of claim 7 wherein said symbols and said mounting plate are constituted by brass.

12. The method of claim 7, further comprising the step of:
(e) attaching said mounting plate to a substrate.
